(19) United States
(12) Patent Application Publication
(10) Pub. No.: US 2006/0074756 A1
(43) Pub. Date: Apr. 6, 2006

(54) Method and system for managing coupon distribution

(75) Inventor: C. Clay Boykin III, Austin, TX (US)

Correspondence Address: William D. Wiese;DuBois, Bryant, Campbell & Schwartz, LLP, Suite 1300, 700 Lavaca Street, Austin, TX, 78701, US

(73) Assignee: BetaCorp Management, Inc.

(21) Appl. No.: 11/240,196

(22) Filed: Sep. 30, 2005

Related U.S. Application Data
(60) Provisional application No. 60/615,073, filed on Oct. 1, 2004.

(51) Int. Cl. G06Q 30/00

(52) U.S. Cl. 705/14

(57) ABSTRACT

A method and system are disclosed for processing coupons through networked computers or kiosks. More particularly, the system has the capability of utilizing data received from one or more networked computers or kiosk to modify coupons subsequently delivered to that kiosk or to other computers or kiosks on the network. The system includes a central server, a series of computers or kiosks networked to the central server, and a software program for collecting the information input by users of the system and modifying the coupons subsequently dispensed through the network based on the information collected.

### PRIORITY CLAIM

The application claims the benefit of priority under 35 U.S.C. §119(e) from U.S. Provisional Application No. 60/615073, entitled, “METHOD AND SYSTEM FOR MANAGING COUPON DISTRIBUTION,” filed on Oct. 1, 2004, which disclosure is incorporated herein by reference.

### TECHNICAL FIELD OF THE INVENTION

The present invention relates to a method and system for managing the distribution of coupons through networked kiosks. More particularly, the invention relates to a method and system for acquiring information from the user of one or more networked kiosks and using that information to monitor and manage the subsequent distribution of coupons to those or other networked kiosks.

### BACKGROUND OF THE INVENTION

Traditional point-of-purchase (POP) solutions, such as shelf-mounted coupon dispensers or post-sale dispensers, can no longer meet the demands of a changing marketplace. Such solutions are typically slow to respond to consumer demand and are not able to excite and motivate consumers. In addition, rapid product revisions, a proliferation of features on those products, high employee turnover, and evolving customer demographics and attitudes create an environment whereby traditional solutions are ineffective.

New technologies are being developed to create interactive retailing solutions, such as coupon distribution, that address the shortcomings of the traditional point-of-purchase approach. These new solutions must interact with the consumer, must have the ability to withstand commercial usage, and must have flexible software if they are going to be successful in influencing buyer behavior.

There is a need in the art for a coupon dispensing system in which information regarding the user's actions can be monitored in real-time and information can be made available to the user in real-time. In addition, the system should be able to provide instantaneous, electronic distribution of coupons across a market, a region or a single location as well as the ability to continuously track coupons issued over the network.

### SUMMARY OF THE INVENTION

The present invention provides a system and method for distributing coupons through networked kiosks. Such system and method not only generates and dispenses coupons, it also has the capability of utilizing data received from one networked kiosk to modify coupons delivered to that kiosk or to other kiosks on the network.

In accordance with one embodiment of the present invention, a system is provided comprising a central server, a series of in-store kiosks networked to the central server and a software program capable of monitoring and managing the distribution of coupons as further described herein.

The kiosks include a user interface and a coupon generating device such as a printer. The user interface may be, for example, a touch screen or a keyboard and monitor, and is used to prompt the user to enter coupon selection data at the user interface which is then recorded. The user interface may include coupon display instrumentation programmed to display available coupon data and the system may allow the user to include or exclude certain coupons from the list of coupons selected by the user. The system's software program may display an attention screen at the user interface, wherein the attention screen is indicative of a product promotion. The system's software program may also display a list of selected coupons and cause the list of selected coupons to be printed at the user interface. The coupon generating device includes instrumentation for transferring the coupon to the user such as by printing the coupon selected by the user on paper or on a card so that the coupon amount can be deducted at the point-of-sale terminal.

When the user inputs information, the information input by the user is sent to the central server. The information may be transferred through any network connection including, for example, the Internet, a local area network, a wide area network or any other type of network. The information may be temporarily or permanently stored at the kiosk prior to sending, at the central server after it has been transmitted, or both.

The information is then analyzed by the software program. The program can detect trends in coupons dispensed between and among kiosks on the network such as, for example, geographically proximate kiosks, kiosks in stores under common ownership and the like. This analysis is performed in real-time as coupons are being dispensed, thereby providing the coupon marketers with current, up-to-date information regarding their coupon program. If the information received from the kiosks deviates from the response desired by the coupon marketer, adjustments can be made to subsequent coupons dispensed from one or more of the kiosks.

Accordingly, it is an object of the present invention to provide a system and method for monitoring and managing the distribution of coupons through a network that incorporates structural and functional features not previously contemplated in traditional coupon systems. Other objects of the present invention will be apparent in light of the description of the invention embodied herein.

This invention, together with the additional features and advantages thereof will become more apparent to those of skill in the art upon reading the description of the preferred embodiments, with reference to the following drawings.

### DESCRIPTION OF THE DRAWINGS

A better understanding of the system and method of the present invention may be had by reference to the drawing figures, wherein:

FIG. 1 is a block diagram showing the preferred embodiment of the present invention;

FIG. 2 is a flow diagram of one embodiment of the present invention;

FIG. 3 is a flow diagram showing the flow of information in one embodiment of the present invention;

FIG. 4 is a diagram showing the functionality of different components within one embodiment of the present invention; and

FIG. 5 is a flow diagram showing one example of the interaction between the user and the system of the present invention.

### DESCRIPTION OF THE PREFERRED EMBODIMENTS

The present invention is an improved method and system for distributing coupons. It should be appreciated that, in addition to the distribution of coupons, the present invention is equally applicable to mystery box prizes, sweepstakes entry forms, special promotional materials, product information, prescription information, recipe information, local and national news, continuity promotions or any form of voucher, ticket or other financial document. Accordingly, references to coupons and other terms used herein may be applicable to vouchers and coupons, as well as other non-financial documents and information. Also, it should be appreciated that, the word “kiosk” as used herein is meant to encompass computers, internet appliances and other devices that may be connected to a network and, accordingly, the word “kiosk” should not be limited to the dictionary definition.

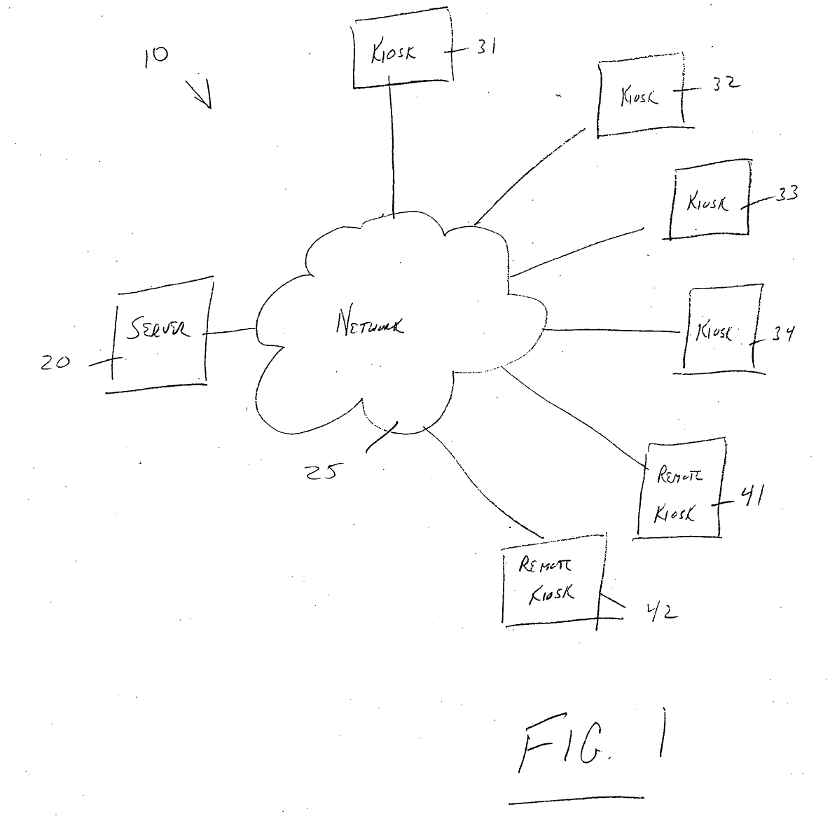

Referring now to the various figures of the drawing wherein like reference characters refer to like parts throughout the several views. FIG. 1 shows a system for dispensing coupons 10. The system for dispensing coupons 10 comprises a central server 20 and a series of kiosks 31, 32, 33 and 34 operatively connected through a network 25 to the central server 20. Each kiosk 31, 32, 33 and 34 includes a user interface such as a display and keypad or a touch screen. The user interface prompts the user to enter coupon selection data at the user interface. The processing of the data after it is input through the interface is described further below. The user interface may be programmed to display an attention screen to indicate a product promotion.

Each kiosk 31, 32, 33 and 34 also includes an apparatus for providing the coupon information to the consumer. The apparatus may include, for example, a printer which prints text and images onto paper drawn from a stock to create a paper coupon which the user can take to the point-of-sale terminal for redemption. Alternatively, the apparatus may include a device for reading and writing a magnetic card which the user can take to the point-of-sale terminal for redemption. In another embodiment, the apparatus may include a device for storing coupon information on a magnetic media card.

In a typical system 10, a plurality of kiosks 31, 32, 33 and 34 will be provided in a plurality of retail stores and interconnected through a network 25. Because the coupons are dispensed by a kiosk at the retail stores, the presentment of coupons can be more responsive to market conditions. For example, a notification by the manufacturer that a promotional discount program is being terminated as a result of lack of availability of merchandise can be immediately remedied by disabling the associated coupon offers. Additionally, items which are subject to rapidly changing market conditions, such as perishables and direct store delivery items, can be discounted, according to the invention, because coupon offers can be created or changed frequently, even instantaneously, hourly or daily, if desired. Moreover, the flexibility inherent in the present invention gives the coupon marketer the ability to change coupon offers in a single store location or in a plurality of store locations. For example, if a product is widely available in one geographic region but not in a second region, coupons can be made available in the first region but not in the second.

The network 25 may be the Internet, a local area network, a wide area network or any other type of network. Alternatively, the network 25 may be a telephone network wherein kiosks communicate with the central server 20 through modems (not shown in FIG. 1). In a telephone network embodiment, kiosks communicate through a modem pool through which the kiosks are connected in a manner well known in the art. Kiosks may also access the network 25 via a satellite communications link, a two way cable broadcast, cellular telephone network, radio frequency (RF) communications, or other wireless communications method. Further, a variety of remote kiosks 41 and 42, not necessarily limited to retail store locations, may be provided throughout the system 10 by any of the foregoing methods. In one embodiment, the network is integrated with the network of the retail store in which the kiosk is located. In another embodiment, security measures, such as encrypted transmissions through the network, may be utilized to protect the information transmitted from the kiosks to the central server and back to the kiosks. An added security feature of the present invention is the capability to determine, on a real-time basis, if the same coupon is repeatedly being requested at a single kiosk in a rapid manner which suggests the possibility of coupon fraud, malfunction or inappropriate usage.

The central server 20 is in communication with the kiosks 31, 32, 33 and 34 and the remote kiosks 41 and 42. A software program is programmed to record the information input by the user into each of the kiosks 31, 32, 33 and 34 and the remote kiosks 41 and 42. The software program may be operative on the central server, the kiosk or on both. Such information may include the type of coupon selected by the user or the number of coupons selected and may also include the location of the kiosk, the time and date of data entry and other information related to the kiosk 31, 32, 33 or 34 or the remote kiosk 41 or 42 itself.

It is noted that specific descriptions or identifications of certain computer-related hardware to be utilized in the present invention is not presented in the above description. However, it is contemplated that one of ordinary skill in the art, in light of that which is generally and conventionally known in the art and in light of the above description of the present invention, will be able identify or design suitable computer-related components and, as such, will be able to make, use, and otherwise practice the present invention by utilizing the suitable components. For example, although a specific, commercially available kiosk user interface is not identified in the above description of the present invention, it is contemplated that a plurality of suitable keyboard and/or display combinations may be utilized in the present invention or, in the alternative, one skilled in the art of user interface design could readily design a keyboard interface for use in practicing the present invention.

The coupon generated by the system contains the usual coupon information found in prior art coupons (e.g. manufacturer, logo of manufacturer's choosing, product description, redemption amount, expiration date, bar code, restrictions on use, etc.). Of particular value in the present invention is the monitoring of user-specific data and trends by the software program whereby marketing analysis can be performed in order to compile future coupons targeted specifically at certain user categories.

In one embodiment of the invention, the software program collects only information regarding the coupons dispensed at each kiosk (e.g. the type of product selected, the amount of the discount, the date and time the coupon was dispensed, etc.) and makes decisions regarding future coupons to be made available at that and other kiosks based on that information alone. In an alternate embodiment, the kiosk verifies the user's identity by collecting certain personally identifiable information from the user. In one approach, the user presents his or her bank-issued ATM card together with his or her PIN number whereupon the user's identity is verified. In another approach, the user is asked to input information which only the user should know, such as date of birth, high school attended, and so on. At the time the user initiates contact with the kiosk, the user answers a few basic questions and, based on the data, the system verifies the identity of the user, based on the user's answers.

Once the software program can verify the specific user, it will then be able to track the user's specific coupon-related decisions (e.g. the product categories of coupons used by the user) and make coupons available to the user accordingly. In this embodiment, the information available to the software program is significantly more robust and more sophisticated algorithms can be utilized when determining the coupons to be offered to the user. For example, if the specific user consistently acquires $1.00 discount coupons for a specific product but does not acquire $0.50 discount coupons for the same product, the software program can be programmed to offer the user $0.75 discount coupons for that product to determine the user's discount threshold.

Once the information is recorded by the software program, the information may be used to determine how future coupons will be distributed on the kiosks 31, 32, 33, or 34 and the remote kiosks 41 and 42. For example, if a series of users at a first kiosk 31 select coupons for a particular product at a particular price at a particular time of day, the software may be programmed to distribute coupons for the same or a marginally higher price at a second kiosk 32 located in the same geographic area as the first kiosk 31. Accordingly, the present invention provides a method and apparatus for targeting specific audiences for coupon distribution. In one embodiment, users of the kiosks are monitored to determine specific preferences. Alternatively, the users may be surveyed to determine preferences.

In one embodiment of the invention, the owner, or an agent of the owner, of the kiosks sells coupon programs to the advertiser. In this embodiment, all changes to the coupon marketer's advertising program, such as the amount of the discount offered, the duration of the coupon program and the like, are entered into the system by the owner, or agent of the owner, of the kiosk. In another embodiment, the coupon marketer can access the system's software program directly by, for example, entering a username and password or a personal identification number. Once the coupon marketer has accessed the system, it can manage their own advertising program without the need for the involvement of the owner or the owner's agent. This gives the coupon marketer the ability to make adjustments to its advertising program instantaneously in response to trends or information received from the kiosks.

The system also has the capability to generate reports showing the activity at the kiosks. This information can be invaluable in managing an advertising program. Moreover, the reports can be generated in such a manner that activity is differentiated along meaningful lines. For example, if a coupon marketer is only interested in seeing coupon activity in a certain city, county or state, the report could be generated to show only that activity. Alternatively, if a coupon marketer was interested in seeing activity by product divisions within a company (e.g. the frozen foods division and the canned goods division), reports could be generated showing only those divisions. Because the reports can be generated and reviewed on a real-time basis, and changes to the coupon marketer's advertising program can be implemented instantaneously, the system and method of the present invention provide a powerful tool for coupon marketers.

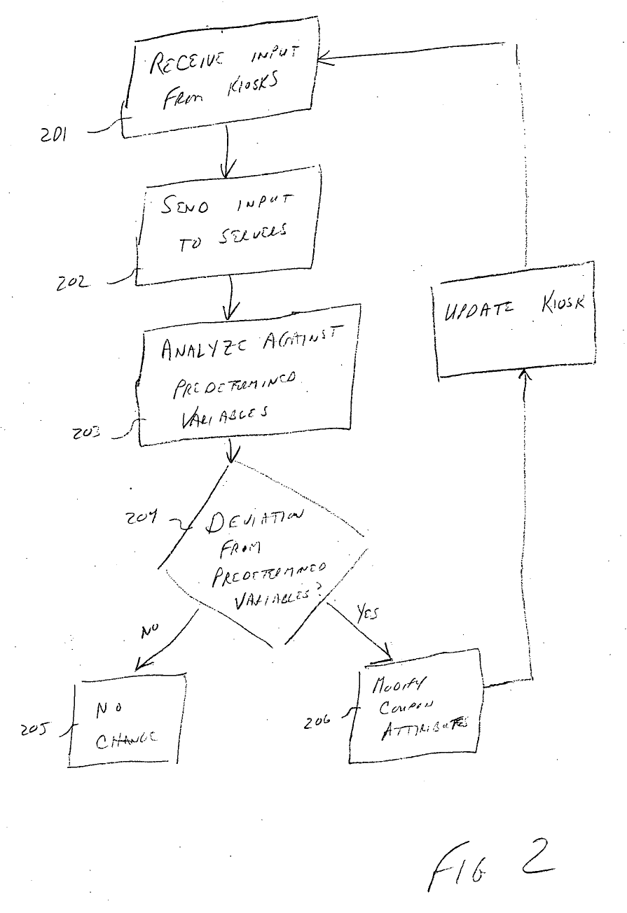

Now referring to FIG. 2 in which a flow diagram of one embodiment of the present invention is shown. According to one aspect of the present invention, the kiosk has a user interface through which the user inputs data into the kiosk 201. The interface may include a coupon display programmed to display available coupon data. The interface may display one or more categories of available coupon data in response to entry of data by the user through the user interface. In this manner, a user may designate the number and type of coupons available for selection according to the nature of the products associated with the coupons. Alternatively, the interface may be programmed to enable a user to exclude certain types of coupons to limit the number and type of coupons available for selection.

The information input by the user is next sent to the central server 202. As discussed above, the information may be transferred through any network connection including, for example, the Internet, a local area network, a wide area network or any other type of network. The information may be temporarily or permanently stored at the kiosk prior to sending, at the central server after it has been transmitted, or both.

Next, the information received from each of the kiosks on the network 203 is analyzed by the software program. The program can detect trends in coupons dispensed between and among kiosks on the network such as, for example, geographically proximate kiosks, kiosks in stores under common ownership and the like. This analysis is performed in real-time as coupons are being dispensed, thereby providing the coupon marketers with current, up-to-date information regarding their coupon program. If the information received from the kiosks deviates from the response desired by the coupon marketer 204, adjustments can be made 206 to subsequent coupons dispensed from one or more of the kiosks. For example, if a $1.00 discount coupon is dispensed at a one kiosk and that coupon is selected by users more than a pre-designated number of times in a certain period, the software program can instruct kiosks in other stores in the same geographic area to dispense the same coupon (if the item may have geographical sensitivities) or instruct kiosks in stores owned by the same retail chain to dispense the same coupon (if the retail chain has subscribed to the service). Alternatively, if, for example, a $1.00 discount coupon does not generate sufficient user interest during a predetermined period, the software program can instruct the kiosks to increase the discount to, for example, $1.25. By adjusting the amount of the discount to achieve the desired demand, the coupon marketer can maximize their impact through the use of coupons.

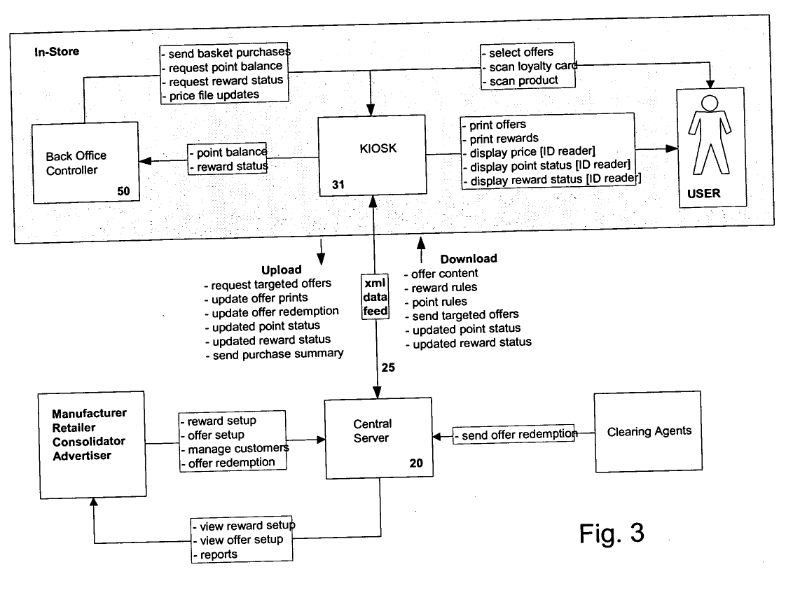

FIG. 3 is a flow diagram showing the flow of information in one embodiment of the present invention. As described above, information flows back and forth between the central server 20 and the kiosk 31 through the network 25. When the user may, for example, select offers available on the kiosk 31, select coupons, scan loyalty cards or scan products. The kiosk 31 will interactively provide to the user such information as print offers, print rewards, prices, point status or reward status. The information aggregated by the kiosk 31 such as point balances and reward status are forwarded into a back office controller 50. The back office controller 50 also provides and receives information regarding, for example, basket purchases, point balances, reward status and price file updates.

Information from the kiosk 31, such as requests for targeted offers, updates of the offers printed, updates of offer redemptions, updates of point status, updates of reward status and purchase summaries, is passed through the network 25 to the central server 20. Conversely, information from the central server 20 is passed through the network 25 to the kiosk 31. This information may be, for example, offer content, reward rules, point rules, information regarding targeted offers, updated point status and updated reward status.

When a manufacturer needs to input information into the system such as, for example, to adjust the terms of a promotional offer as previously described, the manufacturer accesses the central server 20. The manufacturer may, for example, provide information regarding reward setup, provide information regarding offer setup, manage customer accounts or gather information regarding offer redemptions. In addition, clearing agents may interactively provide information regarding offer redemptions to the central server 20.

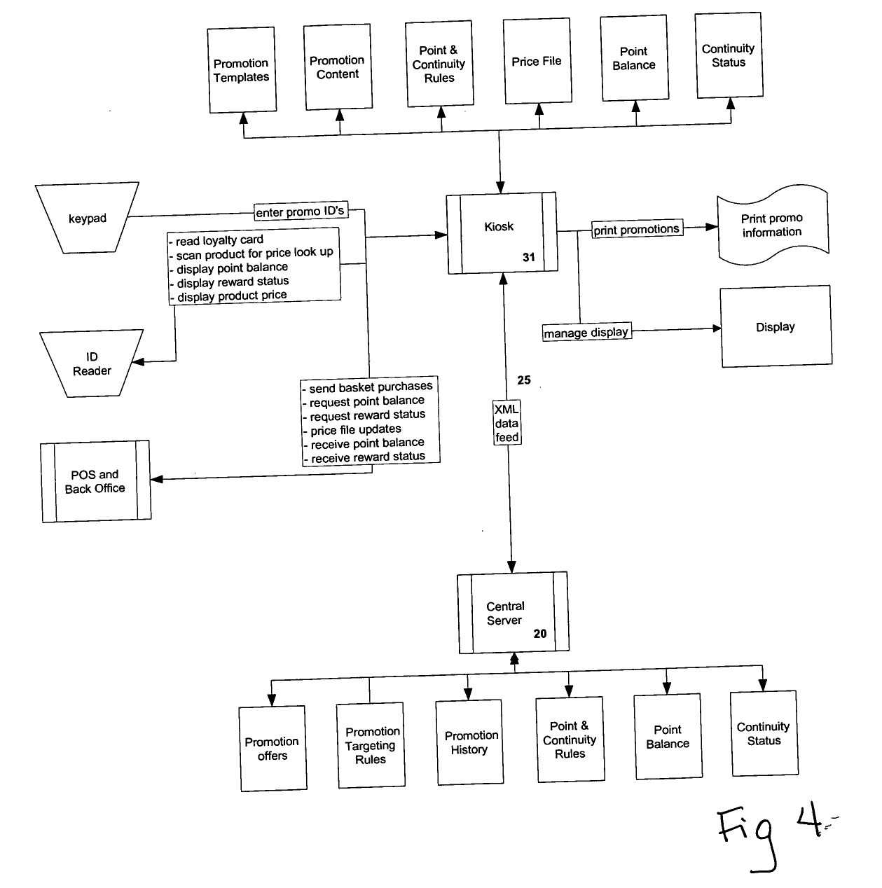

FIG. 4 is a diagram showing the functionality of different components within one embodiment of the present invention. More specifically, the kiosk 31 may utilize input devices as previously described such as, for example, keypads or ID readers. Among other things, the ID readers could be configured to read loyalty cards, scan bar codes on products, display point balances, display reward status and/or display product prices. In addition to transmitting the information to the kiosk, the keypad and the ID reader may also transmit the information to the computer system in the store where the kiosk is located.

The kiosk 31 is capable of providing a variety of information to the user. As shown in FIG. 4, the kiosk 31 may display a promotion template, promotion content, point and continuity rules, price files, point balances and/or continuity status. In addition, the kiosk 31 may print and/or display promotional materials, including recipes utilizing featured products.

A variety of information is also provided to and from the central server 20. Promotional offers, promotion targeting rules, promotion history, point and continuity rules, point balances and continuity status, among other things, may be input, modified and monitored by the central server 20.

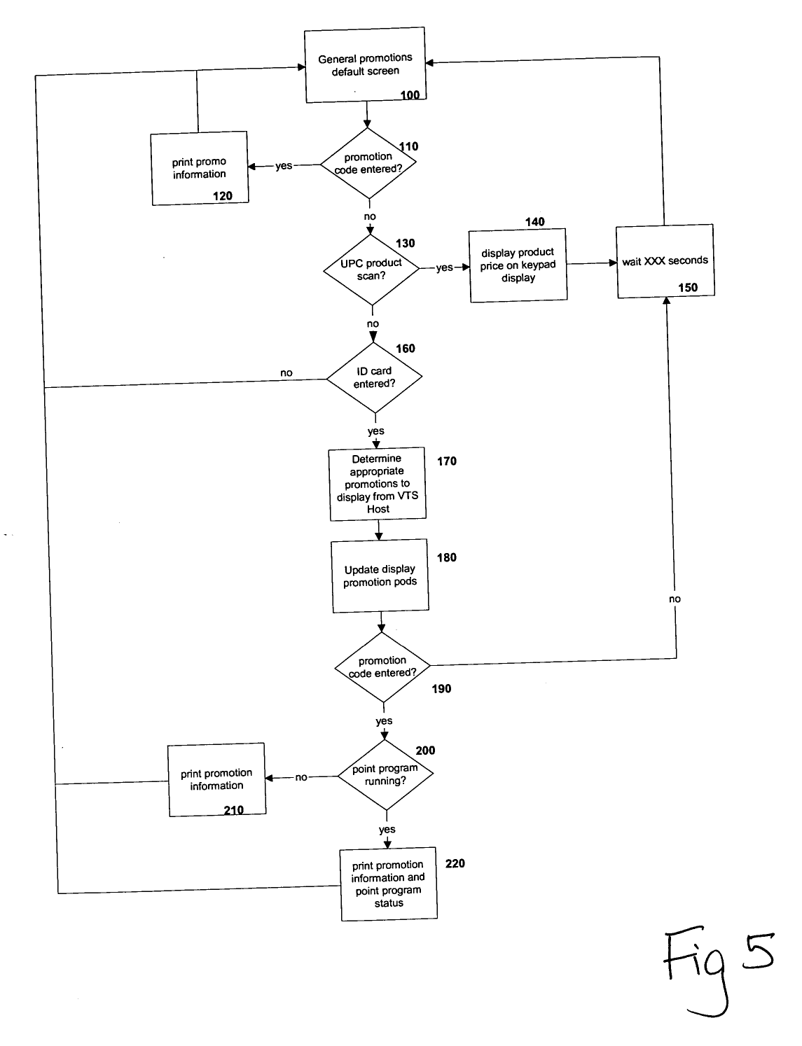

FIG. 5 is a flow diagram showing one example of the interaction between the user and the system of the present invention. The user starts at the general promotions default screen 100. If a promotion code is entered 110, promotional information is printed 120 and the display returns to the general promotions default screen 100. If a universal price code is scanned 130, then the price of the product is displayed on the keypad 140. After waiting a pre-designated number of seconds 150, the display returns to the general promotions default screen 100. If an ID card is entered 160, the system will determine the appropriate promotions to display 170. The promotions are displayed 180 and, if a promotion code is entered 190 and the point program is operational 200, then the system will print promotional information and the user's point program status 220. On the other hand, if the promotion code is not entered 190, the promotions will remain on the display for a pre-designated number of seconds 150 and then the display returns to the general promotions default screen 100. Also, if the point program is not running 200, then the system will simply print the promotional information and the display returns to the general promotions default screen 100.

One benefit of the present invention is that information regarding the user's actions can be monitored in real-time and information can be made available to the user in real-time. As a result, new advertisements or playlists can be downloaded to a kiosk or kiosks at any time. This gives the coupon marketer the ability to commence a new advertisement on an individual kiosk to test the content of the advertisement if so desired. Alternatively, the coupon marketer could elect to run additional advertisements if certain coupons were not being selected by the users. In such a case, the software would be programmed to increase the frequency of that marketer's advertisements if the number of that marketer's coupons selected by users fell below a certain predefined level.

Another benefit of the present invention is the ability to provide instantaneous, electronic distribution of coupons across a market, a region or a single location.

Another benefit of the present invention is the ability to continuously track coupons issued over the network.

Another benefit of the present invention is the ability to provide real-time, remote updates of promotions offered by coupon marketers.

Another benefit of the present invention is the ability to cost-effectively test promotional offers.

The aforementioned benefits are not meant to be limiting nor are they intended to define the scope of the invention set forth in this application.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of kiosk systems, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method for distributing coupons comprising:
locating at least one kiosk in at least one point of sale,
connecting said at least one kiosk through a network to a central server,
aggregating information received from said at least one kiosk at said central server, and
using said aggregated information in determining the nature of promotional offers to be made available on said at least one kiosk in the future.

2. The method of claim 1, wherein said network is selected from the group consisting of the Internet, a local area network and a wide area network.

3. The method of claim 1, wherein said information is temporarily stored on said kiosk prior to being transmitted to said central server.

4. The method of claim 1, wherein said aggregated information includes information selected from the group consisting of the type of coupon selected by a user, the number of coupons selected by said user, the location of said at least one kiosk, and the time and date of said user's use.

5. The method of claim 1, wherein said promotional offers made available at said at least one kiosk include product discounts manifested on printed coupons.

6. The method of claim 1, wherein each of said at least one kiosks includes a user interface selected from the group consisting of a touch screen, a keypad, a keyboard and an ID reader.

7. The method of claim 1, wherein each of said at least one kiosks includes a coupon generating device selected from the group consisting of a printer and a device for writing to magnetic cards.

8. The method of claim 1, wherein said at least one kiosk accesses said network through a device selected from the group consisting of a modem, a satellite communication link, a two-way cable broadcast, a cellular telephone network and radio frequency communication.

9. The method of claim 1, wherein said connection between said at least one kiosk and said network is encrypted.

10. The method of claim 1, wherein said at least one point of sale is a retail store and said at least one kiosk is communicatively connected to the administrative computer system of said retail store.

11. The method of claim 1, wherein said nature of promotional offers to be made available on said at least one kiosk in the future is made available only to certain of said at least one kiosks and not to others.

12. The method of claim 1, wherein said aggregated information is made available in printed reports.

13. A system for distributing coupons comprising:
at least one kiosk located in at least one point of sale,
a central server connected through a network to said at least one kiosk, wherein information is aggregated from said at least one kiosk at said central server, and said aggregated information is used in determining the nature of promotional offers to be made available on said at least one kiosk in the future.

14. The system of claim 13, wherein said network is selected from the group consisting of the Internet, a local area network and a wide area network.

15. The system of claim 13, wherein said information is temporarily stored on said kiosk prior to being transmitted to said central server.

16. The system of claim 13, wherein said aggregated information includes information selected from the group consisting of the type of coupon selected by a user, the number of coupons selected by said user, the location of said at least one kiosk, and the time and date of said user's use.

17. The system of claim 13, wherein said promotional offers made available at said at least one kiosk include product discounts manifested on printed coupons.

18. The system of claim 13, wherein each of said at least one kiosks includes a user interface selected from the group consisting of a touch screen, a keypad, a keyboard and an ID reader.

19. The system of claim 13, wherein each of said at least one kiosks includes a coupon generating device selected from the group consisting of a printer and a device for writing to magnetic cards.

20. The system of claim 13, wherein said at least one kiosk accesses said network through a device selected from the group consisting of a modem, a satellite communication link, a two-way cable broadcast, a cellular telephone network and radio frequency communication.

21. The system of claim 13, wherein said connection between said at least one kiosk and said network is encrypted.

22. The system of claim 13, wherein said at least one point of sale is a retail store and said at least one kiosk is communicatively connected to the administrative computer system of said retail store.

23. The system of claim 13, wherein said nature of promotional offers to be made available on said at least one kiosk in the future is made available only to certain of said at least one kiosks and not to others.

24. The system of claim 13, wherein said aggregated information is made available in printed reports.
